(19) United States
(12) Patent Application Publication
(10) Pub. No.: US 2022/0067146 A1
(43) Pub. Date: Mar. 3, 2022

(54) ADAPTIVE FILTERING OF MALWARE USING MACHINE-LEARNING BASED CLASSIFICATION AND SANDBOXING

(71) Applicant: Fortinet, Inc., Sunnyvale, CA (US)

(72) Inventors: Jun Cai, Coquitlam (CA); Kamran Razi, West Vancouver (CA)

(73) Assignee: Fortinet, Inc., Sunnyvale, CA (US)

(21) Appl. No.: 17/008,807

(22) Filed: Sep. 1, 2020

(51) Int. Cl. G06F 21/53; G06F 21/56; G06N 20/00

(52) U.S. Cl. CPC G06F 21/53; G06F 21/565; G06F 2221/034; G06N 20/00; G06F 21/566

(57) ABSTRACT

Systems and methods for adaptive filtering of malware using a machine-learning model and sandboxing are provided. According to one embodiment, a processing resource of a sandbox appliance receives a file. A feature vector associated with the file is generated by extracting multiple static features from the file. The file is classified based on the feature vector by applying a machine-learning model. When the classification of the file is unknown, representing insufficient information is available to identify the file as malicious or benign, sandbox processing is caused to be performed on the file.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2020, Fortinet, Inc.

### BACKGROUND

### Field

Embodiments of the present invention generally relate to network security and sandboxing. In particular, embodiments of the present invention relate to the prefiltering of a sample under test (e.g., an executable file) using a hybrid model based on static features as well as the dynamic behavior of the sample under test.

### Description of the Related Art

Many existing network security appliances perform signature-based scanning to detect the existence of various forms of malicious software (malware), for example, viruses, spyware, worms, trojans, rootkits, and the like. Signature-based scanning makes use of virus signatures (e.g., continuous sequences of bytes that have been found to be common in an infected file and not in unaffected files). While signature-based scanning remains a useful tool for detecting known malware, signature-based scanning has various disadvantages. For example, creation of the virus signatures relied upon by signature-based scanning is heavily dependent on an analysis performed by human experts and is limited to the evaluation of static features of the files being scanned. Additionally, by making use of emerging Artificial Intelligence (AI) technologies, some malware now has the capability to mutate in an attempt to escape detection by these hard-coded signatures. Furthermore, purely signature-based threat detection systems are unable to detect zero-day threats (e.g., zero-day malware or next-generation malware), representing threats for which specific signatures have yet to be created and/or distributed.

Sandboxing is a technique used to identify zero-day malware based on dynamic behaviors. The fundamental idea behind sandboxing is reducing risk by limiting the environment in which the code under test is executed. Sandboxing involves executing a file within a highly-controlled environment, for example, a virtual container or a virtualized environment. In this manner, malware can be isolated and executed safely without harming any real network assets or impacting resources of the host system. While running a file within a sandbox, dynamic behaviors, for example, registry operations, system configuration changes, file/disk operations, operating system application programming interface (API) calls, and network traffic may be observed, recorded, and analyzed to identify potential security threats. A limitation of sandboxing approaches is the inherently low-bandwidth nature due to the considerable software and hardware resources needed to set up such a virtual environment and the high computational overhead.

### SUMMARY

Systems and methods are described for adaptive filtering of malware using a machine-learning model and sandboxing. According to one embodiment, a processing resource of a sandbox appliance receives a file. A feature vector associated with the file is generated by extracting multiple static features from the file. The file is classified based on the feature vector by applying a machine-learning model. When the classification of the file is unknown, representing insufficient information is available to identify the file as malicious or benign, sandbox processing is caused to be performed on the file.

Other features of embodiments of the present disclosure will be apparent from accompanying drawings and detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 is a block diagram illustrating a sandbox appliance protecting a network environment by performing adaptive filtering of malware in accordance with an embodiment of the present disclosure.

FIG. 2 illustrates functional modules of a malware detection system in accordance with an embodiment of the present disclosure.

FIG. 3A illustrates functional sub-modules of a machine-learning training module in accordance with an embodiment of the present disclosure.

FIG. 3B illustrates functional sub-modules of a sandbox module in accordance with an embodiment of the present disclosure.

FIG. 4 is a block diagram illustrating file processing by machine-learning based pre-filter and sandbox in accordance with an embodiment of the present disclosure.

FIG. 5 is a block diagram illustrating extraction of static features and creation of a binary representation of a feature vector in accordance with an embodiment of the present disclosure.

FIG. 6 is a block diagram illustrating an alternative implementation in which a sandbox application is implemented on a client device in accordance with an embodiment of the present disclosure.

FIG. 7 is a flow diagram illustrating processing of a file by a machine-learning-based prefilter and a sandbox in accordance with an embodiment of the present disclosure.

FIG. 8 is a flow diagram illustrating sandbox processing in accordance with an embodiment of the present disclosure.

FIG. 9 illustrates an exemplary computer system in which or with which embodiments of the present invention may be utilized.

### DETAILED DESCRIPTION

Systems and methods are described for the adaptive filtering of malware using a machine-learning model and sandboxing. According to various embodiments described herein, the scanning throughput and detection range of a sandbox appliance may be increased by making use of a machine-learning model to pre-filter samples before performing sandboxing. For example, new samples may be scanned by a machine-learning model based on static features of the samples to obtain a clean or malware verdict. Then, for those samples that cannot be tagged as clean or malware by the pre-filtering process, sandbox scanning may be performed. Additionally, the machine-learning model may be adjusted to adapt to new emerging malware behaviors by receiving feedback, for example, in the form of a set of updated features from the sandbox appliance. In this manner, a hybrid static-dynamic malware detection system with adaptive filtering for sandboxing systems may be provided.

Embodiments of the present invention include various steps, which will be described below. The steps may be performed by hardware components or may be embodied in machine-executable instructions, which may be used to cause a processing resource (e.g., general-purpose or special-purpose processor) programmed with the instructions to perform the steps. Alternatively, steps may be performed by a combination of hardware, software, firmware, and/or by human operators.

Embodiments of the present invention may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within the single computer) and storage systems containing or having network access to a computer program(s) coded in accordance with various methods described herein, and the method steps of the invention could be accomplished by modules, routines, subroutines, or subparts of a computer program product.

In the following description, numerous specific details are outlined to provide a thorough understanding of example embodiments. It will be apparent, however, to one skilled in the art that embodiments described herein may be practiced without some of these specific details.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein, a “network security appliance” or a “network security device” generally refers to a device or appliance in virtual or physical form that is operable to perform one or more security functions. Some network security devices may be implemented as general-purpose computers or servers with appropriate software operable to perform one or more security functions. Other network security devices may also include custom hardware (e.g., one or more custom Application-Specific Integrated Circuits (ASICs)). A network security device is typically associated with a particular network (e.g., a private enterprise network) on behalf of which it provides the one or more security functions. The network security device may reside within the particular network that it is protecting or network security may be provided as a service with the network security device residing in the cloud. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection, and mitigation, sandbox analysis, encryption (e.g., Internet Protocol Secure (IPSec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), sandbox appliances (e.g., the FORTISANDBOX family of sandbox appliances or the FORTISANDBOX CLOUD cloud-based managed sandbox service), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), and DoS attack detection appliances (e.g., the FORTIDDOS family of DoS attack detection and mitigation appliances).

The phrase “endpoint protection platform” generally refers to cybersecurity monitoring and/or protection functionality implemented on an endpoint device. In one embodiment, the endpoint protection platform can be deployed in the cloud or on-premises and supports multi-tenancy. The endpoint protection platform may include a kernel-level Next Generation AntiVirus (NGAV) engine with machine-learning features that prevent infection from known and unknown threats and leverage code-tracing technology to detect advanced threats such as in-memory malware. The endpoint protection platform may be deployed on the endpoint device in the form of a lightweight endpoint agent that utilizes less than one percent of CPU and less than 100 MB of RAM and may leverage, among other things, various security event classification sources provided within an associated cloud-based security service. Non-limiting examples of an endpoint protection platform include the Software as a Service (SaaS) enSilo Endpoint Security Platform and the FORTICLIENT integrated endpoint protection platform available from Fortinet, Inc. of Sunnyvale, Calif.

As used herein a “network resource” generally refers to various forms of data, information, services, applications, and/or hardware devices that may be accessed via a network (e.g., the Internet). Non-limiting examples of network resources include web applications, cloud-based services, network devices, and/or associated applications (e.g., user interface applications), and network security devices and/or associated applications (e.g., user interface applications).

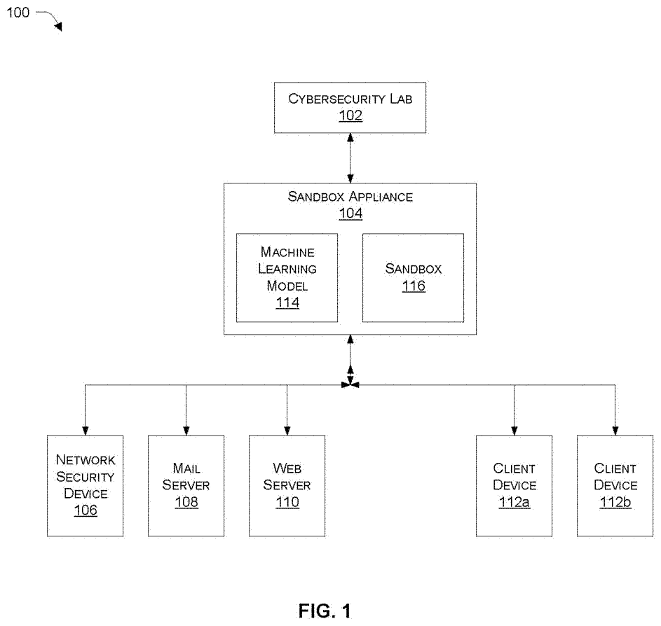

FIG. 1 is a block diagram illustrating a sandbox appliance 104 protecting a network environment by performing adaptive filtering of malware in accordance with an embodiment of the present disclosure. Depending upon the particular implementation, the sandbox appliance 104 may reside within the network environment (e.g., an enterprise network) that it is protecting or may be running, for example, in virtual form within a managed security service provider (MSSP) network or in the cloud. In one embodiment, the sandbox appliance 104 adaptively filter malware including zero-day malware. The sandbox appliance 104 is designed to increase scan throughput and detection range of malware scanning by using a hybrid combination of a machine-learning model 114 and sandbox 116. The machine-learning model 114 may be trained with static features of pre-classified training files (which may be referred to herein as training samples). These static features may be used to predict the actual runtime behavior (the potential capabilities) of a file when it is executed. For example, certain static features may be indicative of registry, file, and/or network operations.

The machine-learning model 114 of the sandbox appliance 104 is initially trained in an offline mode (e.g., in a cybersecurity lab 102) using pre-classified files tagged as benign or malware. After being installed within the sandbox appliance 104, the machine-learning model 114 may receive regular updates from the cybersecurity lab 102 in the form of classified files and train itself using these classified files. The cybersecurity lab 102 or a server assigned with a similar task may collect static features from different sandbox appliances and may regularly update these sandbox appliances with classified files and their associated static features. For example, when the sandbox 116 of the sandbox appliance 104 monitors behavior of unknown files and the file is identified as benign or malware, the sandbox 116 can send the file attributes, comprising of static features and dynamic features of the file to the cybersecurity lab 102. The cybersecurity lab 102 may update the machine-learning model of other sandbox appliances with newly observed static features. Alternatively or additionally, the machine-learning model 114 may be updated as a result of real-time model adjustments provided by an oracle, for example, that provides feedback to the machine-learning model 114 regarding incorrect sample classification

In operation, the sandbox appliance 104 may receive a data stream, also referred interchangeably as a sample under test or a file, from any connected device. In one embodiment, a prefiltering process is applied to the file, including extracting static features of the file, creating a feature vector based on the extracted static features of the file and classifying the file using the machine-learning model 114 as benign or malware, and processing the file accordingly. When a result of the classification indicates the classification of the file is unknown, the sandbox appliance 104 may run the file within sandbox 116 to monitor the dynamic behaviors of the file.

Depending upon the particular implementation, the sandbox appliance 104 may receive the file from a network security device 106, a mail server 108, a web server 110, a client device (e.g., client devices 112a-b). The file received at the sandbox appliance 104 may relate to traffic originating from or destined for any of the network devices of a protected network. Instead of sending all the traffic to sandbox 116, in various embodiments described herein, the sandbox appliance 104 sends only unknown files that the machine-learning model 114 is not able to classify using the static features with enough confidence as either benign or malware. In some embodiments, the prefiltering may include first running the file through a signature-based antivirus (AV) engine and then making use of the machine-learning model 114 when the AV engine identifies the file as benign, which can be treated as an unknown classification as a result of the inaccuracies of AV engines.

Responsive to receipt of a file (e.g., a file having an unknown classification), the sandbox 116 may dynamically create an appropriate virtual environment (e.g., including an operating system (OS), drivers, file managers, applications, and the like) based on the file at issue, and allow the file to execute in this newly created contained virtual environment. In this manner, the sandbox 116 confines the actions of the file, such as attempts to communicate with a network resource, attempts to delete or create system files, use of APIs, attempts to download a file from the Internet, within an isolated environment. Within this safe isolated environment, the sandbox 116 analyzes the dynamic behavior of the file and its various attempted interactions in a pseudo-user environment and uncovers indicators of malicious intent. If something unexpected or wanton is observed, it affects only the sandbox 116 and not the other computers and devices on the network. The sandbox 116 may provide feedback regarding the observed behaviors to the machine-learning model 114 locally and also sent the observed behavior to other deployed sandbox appliances. The observed behaviors may also be sent to the cybersecurity lab 102, which can update other sandbox appliances employing similar machine-learning models.

If any malicious intent is captured, the sandbox 116 may send an alert and relevant threat intelligence report to stop this zero-day attack. The sandbox appliance 104 uses static and dynamic analysis to capture both malware attributes and techniques. Depending upon the particular implementation, the sandbox 116 may be operable to create a number of different virtual environments that emulate various device operating systems, for example, Windows, macOS, Linux, SCADA/ICS, Android, and associated applications and protocols. As those skilled in the art will appreciate, by prefiltering files before resorting to the use of the sandbox 116, the throughput and the detection range of the sandbox appliance 104 increases significantly.

The sandbox appliance 104 may work in coordination with and/or responsive to invocation by other security devices or services, such as AV engines, Web Filtering engines, and the like, to create better protection for the network. When a network device, such as network security device 106, mail server 108, web server 110, client device 112a-b, encounters a suspicious file, it may send the file to the sandbox appliance 104. The sandbox appliance 104 may receive the sample under test (e.g., an executable file) from different a variety of sources including but not limited to network packets, file shares, on-demand submission, and automated submission by a firewall, gateway, end-point protection platform, endpoint detection and response system, and other integrated security controls. The sandbox appliance 104 may report and automatically share any identified threats along with static features and dynamic features observed to other security appliances and the cybersecurity lab 102. In an embodiment, once a threat is detected, the sandbox appliance 104 generates alerts based on an object disposition and shares actionable indicators of compromise (IOCs) intelligence in real-time to other in-line controls across the security architecture to block threats in a coordinated fashion.

Depending upon the particular implementation, the features of sandbox appliance 104 may be implemented by a Virtual Machine (VM) or provided as Software as a Service (SaaS) to suit various on-prem and cloud environment deployments.

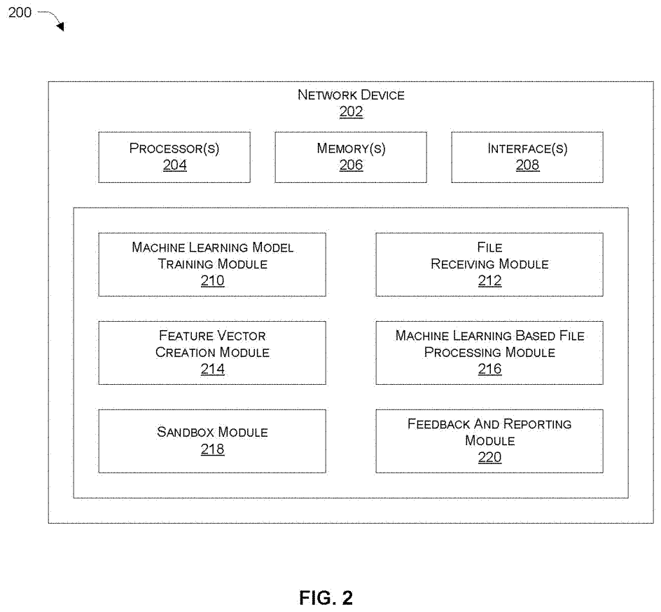

FIG. 2 illustrates functional modules of a malware detection system 200 in accordance with an embodiment of the present disclosure. A network device 202 (e.g., a network security device, such as sandbox appliance 104) having one or more processing resources (e.g., processors 204) is configured to execute programmable instructions associated with functional modules stored in memory 206. The network device 202 may have different input-output interfaces 208, including network interfaces for receiving data from and sending data to other network devices. The interfaces 208 may include an Ethernet interface, a wireless interface, and other communication interfaces. The network device 202 includes a machine-learning model training module 210 configured to received training samples (also referred interchangeably as files) classified as clean and malicious, and train a machine-learning model for classifying a new file into either benign or malicious. The machine-learning model training module 210 may use static features of pre-classified samples for training the machine-learning model. Non-limiting examples of static features include the size of the file, entropy of the file, a certificate associated with the file, API functions imported by the file, an icon present within the file, a .NET header of the file, version information associated with the file, registry keys, import tables, packing methods used by samples, programming languages used, version and type of linker used, presence of byte streams used by common libraries for encryption of files, compilation time of the sample, suspicious printable characters in byte stream, a number of imported API calls, number of data directories used, number of imported libraries, largest length of consecutive American Standard Code for Information Interchange (ASCII) characters, largest length of Hexadecimal (HEX) bytes, and length of copyright field. The machine-learning model 210 may receive regular training samples from other network devices and/or from a central server automatically or through a periodic pull. The machine-learning model training module 210 may extract static features of benign files and malware files. In an embodiment, the machine-learning model training module 210 may receive the static features of benign files and malware files from other security devices. The machine-learning module 210 uses the statics features extracted from training samples to create feature vectors based on which the machine-learning module 210 may classify a new file as benign, malicious, or unknown. The machine-learning training module 210 may use a supervised learning methodology or semi-supervised learning for learning static features of benign files or malicious files.

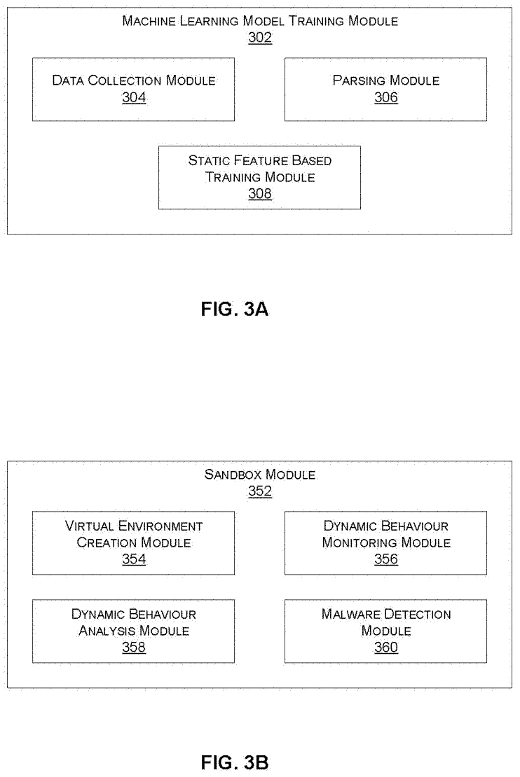

In the context of the present example, the network device 202 includes a file receiving module 212 configured to receive at a file, a feature vector creation module 214 configured to extract static features of the file and create a feature vector based on the static feature, and a machine-learning based file processing module 216 configured to classified the file, using the machine-learning model, as either benign or malware based on matching of the feature vector with feature vectors of benign files and feature vectors of malicious files. Depending on the particular implementation, a feature vector may be in the form of a binary representation of potential capabilities (e.g., potential dynamic behaviors, including registry operations, system configuration changes, file/disk operations, operating system application programming interface (API) calls, and network access) of the sample under test. Based on a statistical model developed by the machine-learning based file processing module 216, the sample under test may be classified as benign, malicious, or unknown. For example, when the machine-learning based file processing module 216 cannot classify the file as either benign or malicious with high confidence, module 216 may mark the file as an unknown file. Such unknown files may be sent to a sandbox module 218 for further processing. When a result of said classification indicates the classification of the file is unknown, representing insufficient information is available to identify the file as malicious or benign, the unknown file is sent for sandbox processing. Additional details regarding an example of the machine-learning based file processing module 216 are described below with reference to FIG. 3A.

The sandbox module 218 on receipt of an unknown file, allows the file to freely operate in a contained virtual environment. The sandbox module 218 is configured to monitor the dynamic behavior of the file as it operates, analyze the monitored behavior, and determine whether the file under test represents a potential threat. Module 218 may provide feedback to the machine-learning training module 210 in the form of observed dynamic features and/or additional static features, for example, the existence API calls discovered within a decrypted Portable Executable (PE) file. The sandbox module 218 may also send an alert or threat report to other network devices, preferably along with the static features and observed dynamic features of the threat file. The sandbox module 218 may create different environments for emulating different operating systems, platforms, and protocols and allows the unknown file to operate in those environments. The sandbox module 218 monitors dynamic behaviors exhibited by the file while being executed within the dynamically created sandbox environment. Additional details regarding an example of the sandbox module 218 are described below with reference to FIG. 3B.

The monitored dynamic behaviors may include one or more of registry operation, a file operation, an operating system application programming interface (API) call, a network connection, and other such activities of the file as it operates or is executed. In an embodiment, the sandbox module 218 may identify additional static features associated with the file as a result of the sandbox processing. For example, decrypting a PE file may reveal the use of an API that was not able to be determined during the prior prefiltering process. As such, in some embodiments, the static features associated with the file under test may be updated and the static analysis may be rerun based on feedback provided by the sandbox module 218.

In the present example, the network device 202 further includes a feedback and reporting module 220 configured to send the identified static features to the machine-learning training module 210 for training. The sandbox module 218 may also update the feature vector of the file based on identified static features and use the machine-learning based file processing module 216 to reclassify the file based on the updated feature vector. The feedback and reporting module 220 may also send feedback and/or an alter to other network devices or other sandbox appliances. The feedback and reporting and module 220 may use a universal security language via a standardized reporting framework to categorize malware techniques and report the identified threat (which may also be referred to herein as malware). In one embodiment, the module 220 may share threat intelligence across a fully integrated security architecture to automate breach protection in real-time as threats are discovered.

In different embodiments, the network device 202 may make use of both passive and active analysis to adaptively learn new malware behaviors. Unknown files may be submitted to the network device 202 (which can be a standalone sandbox appliance) from different network devices. Network device 202 monitors behaviors exhibited by a file in the contained environment to uncover various aspects of the attack life cycle, for example, including sandbox evasion, registry modifications, outbound connections to malicious IP addresses/URLs, infection of processes, file system modifications, and suspicious network traffic.

FIG. 3A illustrates functional sub-modules of a machine model training module 302 in accordance with an embodiment of the present disclosure. As shown in FIG. 3A, the machine-learning training module 302, which represents an example of the machine-learning training module 210, may include a data collection module 304 configured to collect sample data, also referred to as training samples, from different network security devices. The data collection module 304 may receive files classified as either benign or malicious from different sources including but not limited to network packets, file shares, on-demand submission, and automated submission by a firewall, gateway, end-point protection platform, endpoint detection and response system, and other integrated security controls. In the context of the present example, the machine-learning training module 302 further includes a parsing module 306 configured to parse or extract static features from these files, and a static feature based learning module 308 configured to learn from static features of benign files and malicious files. In one embodiment, module 302 trains a machine-learning model based on the learned static features of the benign files and malicious files using a suitable supervised or semi-supervised learning methodology. As described above, the trained machine-learning model may be used as a prefilter to classify a new file as either benign or malicious, and apply or cause to be applied appropriate security measures based on the classification. When the result of the classification is unknown, the unknown file is sent to sandbox 318 for further processing.

FIG. 3B illustrates functional sub-modules of a sandbox module 352 in accordance with an embodiment of the present disclosure. The sandbox module 352 represents a non-limiting example of sandbox module 218 and may include a virtual environment creation module 354 configured to create virtual environments to emulate real network resources and/or end-points, a dynamic behavior monitoring module 356 configured to monitor dynamic behavior of the unknown file as it is allowed to run freely in the contained environment, a dynamic behavior analysis module 358 configured to analyze the monitored behavior of the unknown file, and a malware detection module 360 configured to detect malware in the unknown file based on the analysis of the monitored behavior. The virtual environment creation module 354 creates an isolated environment, which may be referred to interchangeably herein as a contained environment or sandbox environment, in which an unknown file is allowed to run. The dynamic behavior monitoring module 356 is configured to monitor the dynamic behavior of the file as it allows the file to run in the contained environment. The monitoring module 356 monitors malicious activities, including file operations, network connections, registry or system configuration changes, and other such activities. The malware detection module 360 may use a combination of static and dynamic features to identify the presence of malware in the unknown file. In the embodiment, the malware detection module 360 may use an artificial intelligence engine to determine the presence of malware based on the monitored and analyzed behavior of the file. The malware detection module 360 may further classify the malware into different categories based on the observed dynamic behaviors. The sandbox module 352 may report the identified malware along with additionally discovered static features and dynamic features to other modules of the system. A sandbox appliance may gain better efficiency in terms of bandwidth and detectability using the hybrid combination of static feature based filtering by machine-learning model and sandboxing operation.

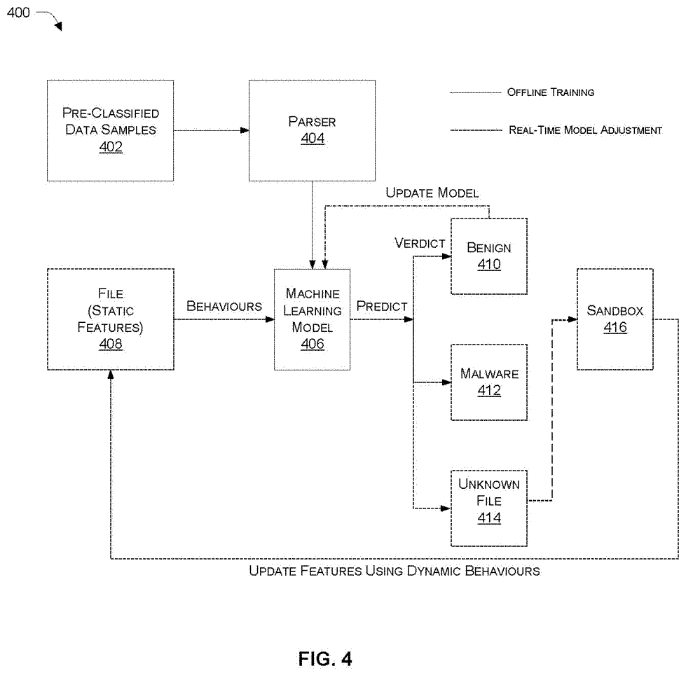

FIG. 4 is a block diagram 400 illustrating file processing by machine-learning based pre-filter and a sandbox in accordance with an embodiment of the present disclosure. As one may observe, the machine-learning model 406 initially received offline training (as shown with the solid lines in FIG. 4), and performs real-time model adjustment (as shown with the dotted lines in FIG. 4) based on feedback received from one or more network devices, users and sandbox 416.

As shown in FIG. 4, a set of pre-classified data samples 402, which includes pre-classified (known) benign files and malicious files, are fed to a parser 404. The parser 404 extracts static features from these data samples 402 and creates feature vectors, which are fed to the machine learning model 406, also referred to as a machine learning based pre-filter. The machine learning model 406 it trained based on these feature vectors associated with pre-classified data samples 402. In an embodiment, once trained the machine learning model 406 may receive a file 408, from a network device, extract static attributes of the file 408, create feature vector and predict whether the file is benign 410 or malware 412. For example, the machine learning model 406 may match the feature vector with feature vectors of the classified data samples 402 and classify the file as benign or malware when the machine learning model 406 has sufficient confidence in such a classification. When the machine learning model 406 is not able to classify the file under test with a high confidence score, the unknown file 414 is sent to sandbox 416. The sandbox 416 may observe the dynamic feature of the unknow file and send it as feedback to the machine learning model 406. The sandbox 416 may identify, based on analysis of the observed behavior, whether the file is clean or malicious. In an embodiment, the machine learning model 406 adjusts itself (is updated) based on real-time feedback received from the sandbox 416.

The machine learning model 406 may receive feedback from an oracle (e.g., a user or other automated process) when a file is classified incorrectly as benign or malware, and perform active adjustment to improve the accuracy of future classification. In an embodiment, the machine learning model 406 sends an alert message to the network device when the file is classified as malicious and allows the other network devices to take preventive actions. In an embodiment, the machine learning model 406 may terminate the file, if the file is classified as malicious. While taking preventive actions, the network devices may perform their own independent analysis to confirm whether the malicious file classification by the machine learning model 406 is correct. A network device may send real-time feedback to the machine learning model 406 if a network device determines that the file was wrongly classified as malicious. The machine learning model 406 can perform real-time model adjustment based on feedback received from the network device. In an embodiment, the machine learning model 406 may send the file classified as benign 410 to a network device. The network device may perform its independent access and if identifies that the file is classified by the machine learning model 406 as benign is a threat, the network may send feedback to the machine learning model 406. The machine learning model 406 can then perform real-time model adjustment based on the received feedback. The machine learning model 406 can be regularly trained on pre-classified data samples received from other network devices.

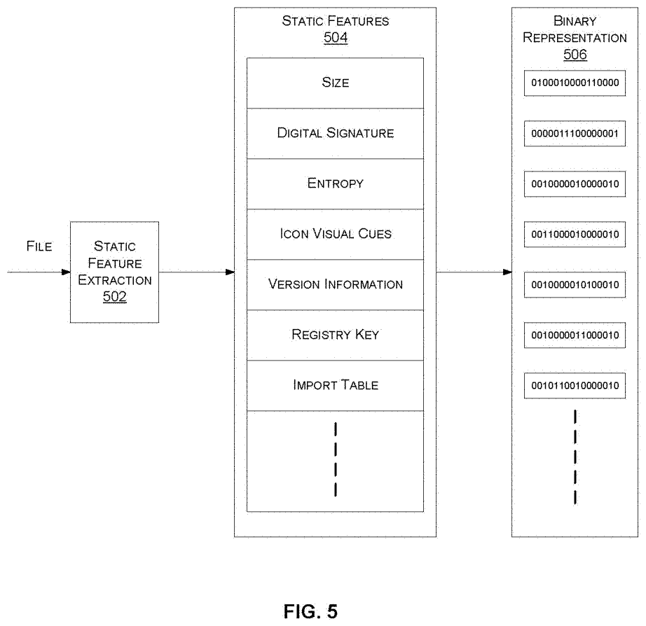

FIG. 5 is a block diagram illustrating extraction of static features and creation of a binary representation of a feature vector in accordance with an embodiment of the present disclosure. As shown in FIG. 5, when a sandbox appliance receives a file, the sandbox appliance may perform static feature extraction 502. The static features 504 may include a size of the file, the entropy of the file, a certificate associated with the file, API functions imported by the file, icon visual cues present within the file, a .NET header of the file, version information associated with the file, registry keys, import tables, packing methods used by samples, programming languages used, version and type of linker used, a detected compiler, an export table, presence of byte streams used by common libraries for encryption of files, compilation time of the sample, suspicious printable characters in byte stream, a number of imported API calls, number of data directories used, number of imported libraries, a largest length of consecutive American Standard Code for Information Interchange (ASCII) characters, a largest length of Hexadecimal (HEX) bytes, and a length of a copyright field. These static features may be further converted into their respective binary representation 506, which may represent a feature vector or be further processed to create the feature vector associated with the file.

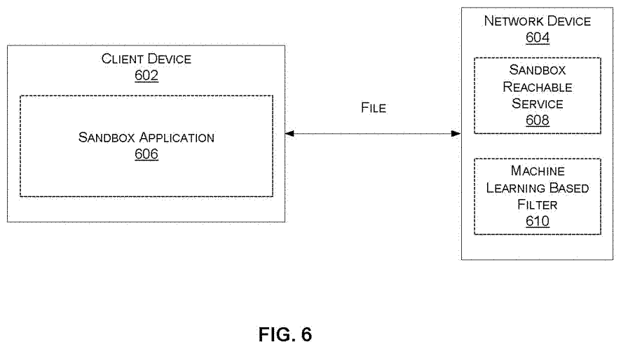

FIG. 6 is a block diagram illustrating an alternative implementation in which a sandbox application is implemented on a client device in accordance with an embodiment of the present disclosure. In an embodiment, some portion or all features of a sandbox appliance (e.g., sandbox appliance 104) may be implemented on a client device 602, for example, as part of an endpoint protection platform. The client device 602 may execute one or more functional modules of the sandbox appliance 104. The client device 602 may be configured with a sandbox application 606, which can perform sandboxing at the client device 602. A network device 604 may include a sandbox reachable service 608 and a machine learning based filter 610. The network device 604 may perform static feature based filtering using the machine learning based filter 610 and send the unknown file through sandbox reachable service 608 to the sandbox application 606. The machine learning based filter 610 classifies the file received at the network device 604 into benign or malicious and sends an internal message to sandbox reachable service 608 when it is unable to classify the file as either benign or malicious with sufficient confidence. The unknown file is sent by the sandbox reachable service 608 to the sandbox application 606 at the client device 702, where sandboxing operations may be performed to understand the dynamic behavior of the file. The sandbox application 606 may then identify, using the observed dynamic features, whether the unknown file is perceived to be a threat. In the context of the present example, as the sandboxing is perform at the client device 602, a more realistic environment may be provided. As the file is transferred or forwarded from the network device to the client device, any malware associated with the file may be led to believe that it has been allowed in the network and therefore may trigger its operation.

In an embodiment, network resources can be configured with sandbox application and the network device 604 may forward the file to a respective network resource to which the file was originally sent for performing the sandboxing. The network resource, which can be an end-user device, with a sandbox application first opens the file in a contained virtual environment, monitors the dynamic behavior of the file, and allows the files to operate in a real environment only when it is found to be clean.

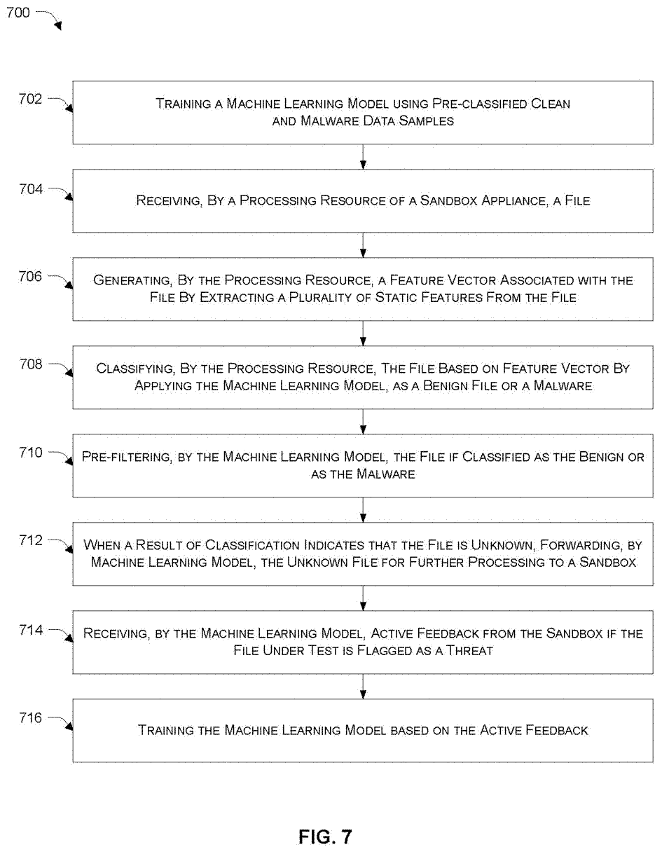

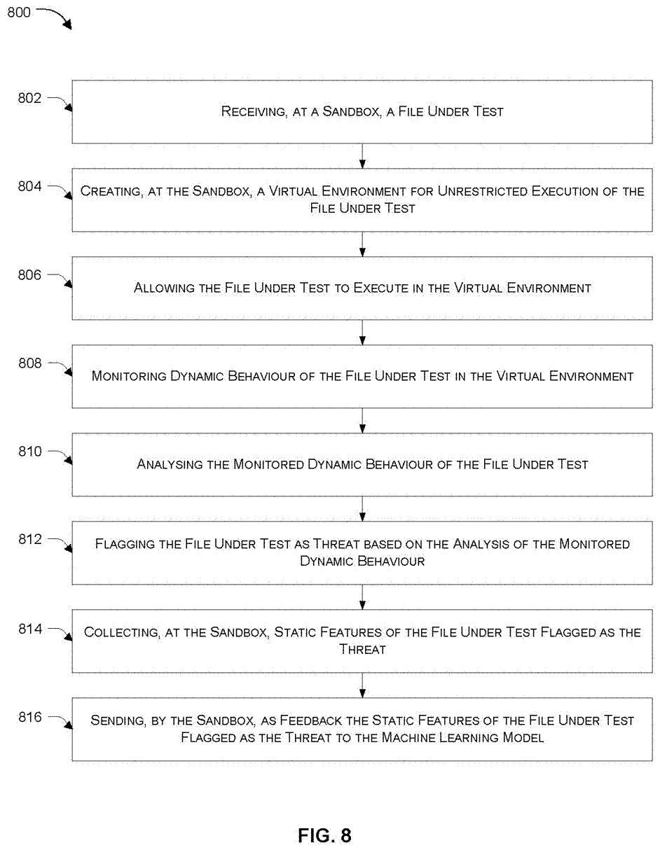

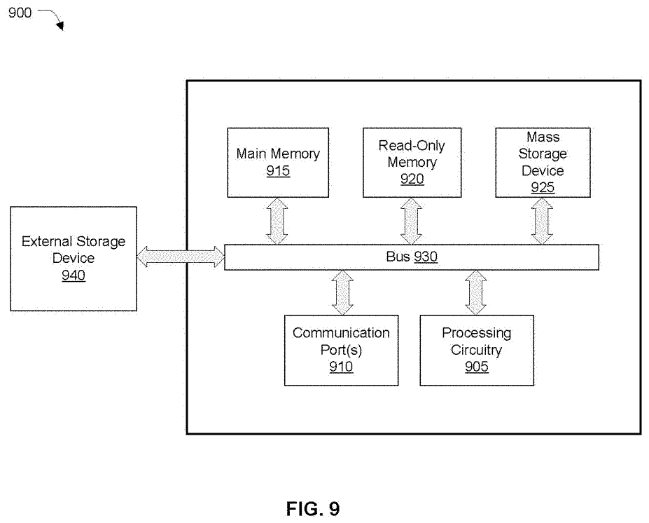

The various appliances (e.g., sandbox appliance 104) and network devices (e.g., network device 202) described herein and the processing described below with reference to the flow diagrams of FIGS. 7-8 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems of various forms, such as the computer system described with reference to FIG. 9 below.

FIG. 7 is a flow diagram 700 illustrating processing of a file by a machine learning-based prefilter and a sandbox in accordance with an embodiment of the present disclosure. In the context of the present example, a machine-learning model (e.g., machine-learning model 406) is used to pre-filter samples before resorting to performing sandboxing. For example, new samples may be scanned by a machine-learning model based on static features of the samples to obtain a clean or malware verdict. Then, for those samples that cannot be tagged as clean or malware by the pre-filtering process with sufficient confidence, sandbox scanning may be performed to observe dynamic behaviors of the sample within a contained environment. In this manner, a hybrid static-dynamic malware detection system with is provided in which the scanning throughput and the detection range of the sandbox appliance may be increased.

At block 702, a machine-learning model is trained using known (pre-classified or labeled) clean and malware samples. As noted above, this training process may be performed separately from operation of a sandbox appliance (e.g., sandbox appliance 104), for example, in a cybersecurity lab (e.g., cybersecurity lab 102). In one embodiment, the machine-learning model may make use of the Gradient Boosting Decision Tree (GBDT) algorithm or a GBDT algorithm with Gradient-based One-Side Sampling (GOSS) and Exclusive Feature Bundling (EFB) referred to as LightGMB. An advantage of using decision trees is the ability of humans to review and understand the relevant decision paths, which gives an administrator the ability to correct errors for purposes of facilitating real-time model adjustment. As those skilled in the art will appreciate, other type of machine learning models, for example, those known as neural-network systems, are also commonly used. These types of models work best on a large number of data points and available recursive training algorithms let them comb through data points without needing a large amount of dedicated hardware resources. The maintenance benefit is to call the training again to emphasize some new data points that the network previously tagged incorrectly without changing the entire behavior of the network. A non-limiting example of a neural-network system is a Multi-Layer Perceptron network.

At block 704, a sample under test (e.g., a file) is received by a processing resource of the sandbox appliance. The file may be provided to the sandbox appliance by a client device, a network device, or network security device protecting the private network or the file may be received directly by the sandbox appliance from an external network.

Blocks 706-710 may represent a prefiltering process that limits the volume of samples that are processed by a sandbox. At block 706, a feature vector associated with the file is generated by extracting multiple static features of the file. According to one embodiment, these static features may be used to predict the actual runtime behavior (the potential capabilities) of a file when it is executed. For example, certain static features may be indicative of the use of registry, file, and/or network operations by the file.

At blocks 708, the machine learning model classifies the file as benign or malware based on the feature vector by applying the trained machine learning model.

At block 710, if the file is classified as benign or as malware with a sufficient level of confidence, for example, satisfying a predetermined or configurable confidence score, then the file can be handled in accordance with the classification

At block 712, when a result of the classification indicates that the file is unknown, the file may be forwarded to a sandbox (e.g., sandbox 116) for further processing. In one embodiment, when the machine learning model is unable to classify the file as benign or malware with a sufficient level of confidence, then the machine learning model classifies the file as unknown and the file is forwarded to the sandbox for further processing. An example of processing that may be performed by the sandbox is described further below with reference to FIG. 8.

At block 714, feedback is received by the machine-learning model from the sandbox. In one embodiment, regardless of the classification by the sandbox, feedback may be provided to the machine-learning model. The feedback may be in the form of the classification made by the sandbox and a set of updated features reflecting, for example, static features discovered during the sandbox processing. For example, as a result of decrypting a PE file, certain static features (e.g., the use of one or more API calls) may become apparent.

At block 716, the machine-learning model may be updated (or retrained) based on the feedback provided by the sandbox. In one embodiment, the machine-learning model has the ability to learn continually based on one or more of feedback received from the sandbox and oracle feedback (e.g., feedback from a user regarding the accuracy of its predictions).

FIG. 8 is a flow diagram 800 illustrating sandbox processing in accordance with an embodiment of the present disclosure. At block 802, a file under test is received by a sandbox (e.g., sandbox 116). In one embodiment, as part of a prefiltering process, the file has previously been attempted to be classified as benign or malware, but was unable to be placed into either category with sufficient certainty and therefore has been classified as an unknown file.

At block 804, a virtual environment is created by the sandbox in which the file under test may be executed. Depending upon the particular implementation, the sandbox may dynamically create an appropriate virtual environment (e.g., including an operating system (OS), drivers, file managers, applications, and the like) based on the file at issue.

At block 806, the file under test is allowed to execute in the virtual environment.

At block 808, dynamic behaviors of the file under test is monitored as it executes within the virtual environment. For example, registry operations, attempted system configuration changes, file/disk operations, OS API calls, and network traffic may be observed and recorded

At block 810, the dynamic behaviors exhibited by the file under test are analyzed. In one embodiment, certain dynamic behaviors are indicative of potential security threats and their presence or absence may be used to classify the file under test as benign or malware at block 812.

At block 814, static features, which may not have been observable during the prior prefiltering stage may be identified based on the dynamic behavior. For example, once the file is running within the virtual environment, the use of API calls may become apparent and information regarding a set of updated static features reflecting newly observed features may be collected regarding the file under test.

At block 816, feedback may be provided to the machine learning model. In one embodiment, regardless of the classification by the sandbox, feedback may be provided to the machine-learning model, for example, in the form of the classification made by the sandbox and a set of updated features reflecting, for example, static features discovered during the sandbox processing. For example, as noted above, as a result of decrypting a PE file, certain static features (e.g., the use of one or more API calls) may become apparent.

FIG. 9 illustrates an exemplary computer system in which or with which embodiments of the present invention may be utilized. As shown in FIG. 9, a computer system includes an external storage device 940, a bus 930, a main memory 915, a read-only memory 920, a mass storage device 925, a communication port 910, and one or more processing resources (e.g., processing circuitry 905). Computer system 900 may represent some portion of a sandbox appliance (e.g., sandbox appliance 104), a network device (e.g., network device 202 or 604), or a client device (e.g., client device 602).

Those skilled in the art will appreciate that computer system 900 may include more than one processor and communication ports 910. Examples of processing circuitry 905 include, but are not limited to, an Intel® Itanium® or Itanium 2 processor(s), or AMD® Opteron® or Athlon MP® processor(s), Motorola® lines of processors, FortiSOC™ system on chip processors or other future processors. Processing circutry 905 may include various modules associated with embodiments of the present invention.

Communication port 910 can be any of an RS-232 port for use with a modem-based dialup connection, a 10/100 Ethernet port, a Gigabit or 10 Gigabit port using copper or fiber, a serial port, a parallel port, or other existing or future ports. Communication port 910 may be chosen depending on a network, such as a Local Area Network (LAN), Wide Area Network (WAN), or any network to which the computer system connects.

Memory 915 can be Random Access Memory (RAM), or any other dynamic storage device commonly known in the art. Read-Only Memory 920 can be any static storage device(s) e.g., but not limited to, a Programmable Read-Only Memory (PROM) chips for storing static information e.g. start-up or BIOS instructions for processing circuitry 905.

Mass storage 925 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 930 communicatively couples processing circuitry 905 with the other memory, storage, and communication blocks. Bus 930 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processing circuitry 905 to a software system.

Optionally, operator and administrative interfaces, e.g. a display, keyboard, and a cursor control device, may also be coupled to bus 930 to support direct operator interaction with the computer system. Other operator and administrative interfaces can be provided through network connections connected through communication port 910. An external storage device 940 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

What is claimed is:

1. A method comprising:
receiving, by a processing resource of a sandbox appliance, a file;
generating, by the processing resource, a feature vector associated with the file by extracting a plurality of static features from the file;
classifying, by the processing resource, the file based on the feature vector by applying a machine-learning model; and
when a result of said classifying indicates classification of the file is unknown, representing insufficient information is available to identify the file as malicious or benign, causing, by the processing resource, sandbox processing to be performed on the file.

2. The method of claim 1, further comprising prior to said classifying, pre-filtering, by the processing resource, the file by performing signature-based scanning on the file.

3. The method of claim 1, wherein the sandbox processing involves monitoring dynamic behaviors exhibited by the file while being executed within a sandbox environment.

4. The method of claim 3, wherein the dynamic behaviors include one or more of a registry operation, a file operation, an operating system application programming interface (API) call, and a network connection.

5. The method of claim 1, further comprising:
identifying, by the processing resource, one or more additional static features associated with the file as a result of the sandbox processing;
updating, by the processing resource, the feature vector based on the one or more additional static features; and
re-classifying, by the processing resource, the file based on the updated feature vector by re-applying the machine-learning model.

6. The method of claim 1, wherein the static features comprises any or combination of a size of the file, entropy of the file, a certificate associated with the file, API functions imported by the file, an icon present within the file, a .NET header of the file, version information associated with the file, registry keys, import tables packing methods used by samples, programming languages used, version and type of linker used, presence of byte streams used by common libraries for encryption of files, compilation time of the sample, suspicious printable characters in byte stream, a number of imported API calls, number of data directories used, number of imported libraries, largest length of consecutive American Standard Code for Information Interchange (ASCII) characters, largest length of Hexadecimal (HEX) bytes, and length of copyright field.

7. The method of claim 1, further comprising training, by the processing resource, the machine-learning model based on static features associated with a plurality of known samples including both benign and malicious samples.

8. The method of claim 1, further comprising updating, by the processing resource, the machine-learning model based on feedback received from an oracle regarding said classifying.

9. A sandbox appliance comprising:
a processing resource; and
a non-transitory computer-readable medium, coupled to the processing resource, having stored therein instructions that when executed by the processing resource cause the processing resource to:
receive a sample under test;
generate a feature vector associated with the sample under test by extracting a plurality of static features from the sample under test;
classify the sample under test based on the feature vector by applying a machine-learning model; and
when a result of classification of the sample under test is unknown, representing insufficient information is available to identify the sample under test as malicious or benign, cause sandbox processing to be performed on the sample under test.

10. The sandbox appliance of claim 9, wherein the instructions further cause the processing resource to prior to classification of the sample under test, prefilter the sample under test by performing signature-based scanning on the sample under test.

11. The sandbox appliance of claim 9, wherein the sandbox processing involves monitoring dynamic behaviors exhibited by the sample under test while being executed within a sandbox environment.

12. The sandbox appliance of claim 11, wherein the dynamic behaviors include one or more of a registry operation, a file operation, an operating system application programming interface (API) call, and a network connection.

13. The sandbox appliance of claim 9, wherein the instructions further cause the processing resource to:
identify one or more additional static features associated with the sample under test as a result of the sandbox processing;
update the feature vector based on the one or more additional static features; and
re-classifying the sample under test based on the updated feature vector by re-applying the machine-learning model.

14. The sandbox appliance of claim 9, wherein the sample under test comprises a file and wherein the static features comprises any or combination of a size of the file, entropy of the file, a certificate associated with the file, API functions imported by the file, an icon present within the file, a .NET header of the file, version information associated with the file, registry keys, import tables packing methods used by samples, programming languages used, version and type of linker used, presence of byte streams used by common libraries for encryption of files, compilation time of the sample, suspicious printable characters in byte stream, a number of imported API calls, number of data directories used, number of imported libraries, largest length of consecutive American Standard Code for Information Interchange (ASCII) characters, largest length of Hexadecimal (HEX) bytes, and length of copyright field.

15. The sandbox appliance of claim 9, wherein the instructions further cause the processing resource to update the machine-learning model based on feedback received from an oracle regarding classification of the sample under test.

16. A non-transitory machine readable medium storing instructions that when executed by a processing resource of a sandbox appliance cause the processing resource to:
receive a sample under test;
generate a feature vector associated with the sample under test by extracting a plurality of static features from the sample under test;
classify the sample under test based on the feature vector by applying a machine-learning model; and
when a result of classification of the sample under test is unknown, representing insufficient information is available to identify the sample under test as malicious or benign, cause sandbox processing to be performed on the sample under test.

17. The non-transitory machine readable medium of claim 16, wherein the instructions further cause the processing resource to prior to classification of the sample under test, prefilter the sample under test by performing signature-based scanning on the sample under test.

18. The non-transitory machine readable medium of claim 16, wherein the sandbox processing involves monitoring dynamic behaviors exhibited by the sample under test while being executed within a sandbox environment.

19. The non-transitory machine readable medium of claim 18, wherein the dynamic behaviors include one or more of a registry operation, a file operation, an operating system application programming interface (API) call, and a network connection.

20. The non-transitory machine readable of claim 16, wherein the instructions further cause the processing resource to:
identify one or more additional static features associated with the sample under test as a result of the sandbox processing;
update the feature vector based on the one or more additional static features; and
re-classifying the sample under test based on the updated feature vector by re-applying the machine-learning model.
